(19) United States
(12) Patent Application Publication
(10) Pub. No.: US 2026/0049573 A1
(43) Pub. Date: Feb. 19, 2026

(54) PROPELLER OF AN AIRCRAFT TURBINE ENGINE AND METHOD FOR DE-ICING SAME

(71) Applicant: SAFRAN NACELLES, GONFREVILLE-L'ORCHER (FR)

(72) Inventor: Pierre Charles CARUEL, MOISSY-CRAMAYEL (FR)

(73) Assignee: SAFRAN NACELLES, GONFREVILLE-L'ORCHER (FR)

(21) Appl. No.: 19/476,476

(22) PCT Filed: May 3, 2024
(86) PCT No.: PCT/EP2024/062228

§ 371 Date: Oct. 20, 2025

(30) Foreign Application Priority Data
May 10, 2023 (FR) 2304651

(51) Int. Cl. F02C 7/047

(52) U.S. Cl. CPC F02C 7/047; F05D 2220/323

(57) ABSTRACT

The invention relates to a propeller (1) of an aircraft turbine engine, comprising a cone (2) and a plurality of blades (3), the propeller (1) comprising a plurality of electrical de-icing members (4) rigidly connected to a wall (30) of the blades (3), and a control system (6) electrically connected to the electrical de-icing members (4) and comprising at least one electrical switch (7A) having a variable switching duty cycle which is configured, using an input electrical power (Pe), to distribute an output electrical power (Ps) to the electrical de-icing members (4) and to emit a dissipated electrical power (Pd) in the form of heat, at least one electrical switch (7A) of the control system (6) being mounted on an inner face (21) of a wall (20) of the cone (2) so as to transfer the dissipated electrical power (Pd) by thermal conduction into the wall (20) of the cone.

The invention relates to a propeller (I) of an aircraft turbine engine, comprising a cone (2) and a plurality of blades (3), the propeller (I) comprising a plurality of electrical de-icing members (4) rigidly connected to a wall (30) of the blades (3), and a control system (6) electrically connected to the electrical de-icing members (4) and comprising at least one electrical switch (7A) having a variable switching duty cycle which is configured, using an input electrical power (Pe), to distribute an output electrical power (Ps) to the electrical de-icing members (4) and to emit a dissipated electrical power (Pd) in the form of heat, at least one electrical switch (7A) of the control system (6) being mounted on an inner face (21) of a wall (20) of the cone (2) so as to transfer the dissipated electrical power (Pd) by thermal conduction into the wall (20) of the cone.

### TECHNICAL FIELD

The present invention relates to the field of the aircraft turbine engines and more particularly to the de-icing of a propeller of an aircraft turbine engine.

In a known way, an aircraft turbine engine comprises a propeller upstream of the air inlet of the turbine engine. The propeller comprises a cone enclosing a hub and a set of blades extending radially from the hub. The propeller is driven in rotation by a rotating shaft of the turbine engine, in practice via a speed reducer referred to the person skilled in the art as a Reduction Gear Box (RGB).

During the aircraft flight, ice is likely to form on the propeller. The ice build-up is undesirable because it may affect the weight of the propeller, its balance around the axis of rotation and its aerodynamics. In addition, the detachment of a block of ice from the propeller may lead to its ingestion into the turbine engine, which may damage it.

To prevent the formation and/or the accumulation of ice, it is known to position heating elements on the wall of the blades at the level of the leading edge and, in some cases, on the wall of the cone. The heating elements take the form of heating mats comprising electrical resistors, which are activated in the presence of icing conditions. This prevents the formation of ice and/or loosens the ice that is ejected from the turbine engine by the centrifugal force of the rotation of the propeller.

It is known from the application FR3096080A1 that the heating elements are supplied electrically by a permanent magnet alternator mounted in the accessory gearbox, referred to the person skilled in the art as the “Accessory Gear Box (AGB)”. The permanent magnet alternator produces a direct electric current from a torque applied to a rotating shaft in the turbine engine. An inverter converts the direct current into alternating current, which is transmitted by a rotating transformer to the heating elements mounted in the rotating propeller. The rotating transformer comprises a rotor coupled in rotation to the propeller and a stator mounted in a stationary part of the turbine engine, for example in the cavity delimited by the compressor casing.

To ensure de-icing is both effective and without risk of overheating the propeller, it is known to control the electrical power supplied to the heating elements using a set of switches. In practice, each switch takes the form of a power electronics component, such as a transistor (IGBT, etc.). The switch set comprises a switching duty cycle that may be adjusted as a function of climatic conditions and the operating speed of the turbine engine. The switch set must be mounted between the rotary transformer and the heating elements, so that there is only one rotary transformer for all the heating elements. This means that the switch set must be positioned in the cavity delimited by the cone, centered with respect to the rotary axis of the cone, to avoid an unbalanced effect.

In practice, the switch set dissipates part of the electrical power transmitted by the rotating transformer in the form of heat, up to a few percent. Such overheating of a power electronics component is undesirable and requires a ventilation device to be integrated into the cone, which increases on-board mass, complexity and cost.

The invention thus aims to eliminate at least some of these disadvantages.

It is known from the patent EP2218643B1 that the blades of an aircraft propeller may be de-iced using internal resistors whose power supply is controlled by semiconductor switches. The closing of the switches is controlled by an optical pulse received by a photoelectric sensor mounted downstream of the cone. The patent EP3135587B1 relates to the de-icing of a stationary part of an aircraft, in particular the air inlet, the fuselage or the wing.

In addition, climate change is a major concern for many legislative and regulatory bodies around the world. Various restrictions on carbon emissions have been, are being or will be adopted by different countries. In particular, an ambitious standard applies both to new types of aircrafts and to those already in circulation, requiring the implementation of technological solutions so as to bring them into line with current regulations. For several years now, the civil aviation has been working to help combat climate change.

The technological research efforts have already led to very significant improvements in the environmental performance of the aircrafts. The Applicant takes into account the impacting factors in all phases of design and development to obtain aeronautical elements and products that consume less energy, are more environmentally friendly and whose integration and use in civil aviation have moderate environmental consequences with the aim of improving the energy efficiency of the aircrafts.

Consequently, the Applicant is constantly working to reduce its negative impact on the climate through the use of virtuous development and manufacturing methods and processes that minimize emissions of greenhouse gases to the minimum possible in order to reduce the environmental footprint of its business.

This sustained research and development work concerns new generations of aircraft engines, the lightening of the aircrafts, in particular through the materials used and the lighter on-board items of equipment, the development of the use of electrical technologies for propulsion and, as an essential complement to the technological progress, the aeronautical biofuels.

To this end, the invention is the result of technological research aimed at significantly improving the performances of the aircrafts and, in this sense, contributes to reducing the environmental impact of the aircrafts.

### PRESENTATION OF THE INVENTION

The invention relates to a propeller for an aircraft turbine engine comprising a cone and a plurality of blades, the cone extending along a longitudinal axis oriented from upstream to downstream and being configured to be driven in rotation by a shaft of the aircraft turbine engine, the cone comprising a wall with an inner face and an outer face, the propeller comprising:
a plurality of electrical de-icing members secured to a wall of the blades in order to de-ice them,
a control system electrically connected to the electrical de-icing members and comprising at least one electrical switch having a variable switching duty cycle configured, from an input electrical power, to distribute an output electrical power to the electrical de-icing members and to emit a dissipated electrical power in the form of heat.

The invention is remarkable in that at least one electrical switch of the control system, referred to as the “electrical de-icing switch”, is mounted on the inner face of the wall of the cone so as to transfer the dissipated electrical power by thermal conduction into the wall of the cone.

Advantageously, the invention allows to promote the cooling of the control electronics mounted in the cone of the propeller to ensure the de-icing of the blades. The mounting of the electrical switches on the wall of the cone allows the dissipated electrical power dissipated in the form of heat by the electrical switches to be transferred to the wall of the cone by thermal conduction. In this way, the heat emitted by the electrical switches is efficiently dissipated to the outside instead of accumulating inside the cone. No cooling device is required in the cone. Positioning the electrical switches in this way also allows to contribute directly to de-icing the cone of the propeller, because the dissipated electrical power dissipated in the form of heat by the electrical switches heats up the wall of the cone by thermal conduction.

According to one aspect of the invention, the electrical de-icing switch or switches have an overall center of inertia belonging to the longitudinal axis. This prevents the cone from becoming unbalanced.

According to one aspect of the invention, the control system comprises a plurality of electrical de-icing switches, the electrical de-icing switches being arranged on at least one section of the cone extending transversely with respect to the longitudinal axis. The electrical de-icing switches are advantageously arranged longitudinally in relation to the cone according to the de-icing requirement, which depends on the flow conditions of the inlet air flow.

According to a first aspect of the invention, the propeller comprises:
a plurality of electrical de-icing members secured to the wall of the cone and arranged on at least one section of the cone extending transversely with respect to the longitudinal axis and having a given longitudinal position referred to as the “reference de-icing position”,
the electrical de-icing switches being arranged on a section referred to as the “upstream section” extending upstream of the reference de-icing position or on a section referred to as the “downstream section” extending downstream of the reference de-icing position.

The electrical de-icing members thus ensure a de-icing in the area most prone to frost, where the incoming air flow is attached to the wall. The upstream electrical de-icing switches de-ice the leading edge of the cone, where the air flow is detached from the wall and less de-icing is required. The need for de-icing is also lower further downstream of the cone.

According to a second aspect of the invention, the propeller comprises:
a plurality of electrical de-icing members secured to the wall of the cone and arranged on at least one section of the cone extending transversely with respect to the longitudinal axis and having a longitudinal position referred to as the “reference de-ice position”,
the electrical de-icing switches being arranged on a section referred to as the “upstream section” extending upstream of the reference de-icing position, and on a section referred to as the “downstream section” extending downstream of the reference de-icing position.

Such an architecture advantageously allows a significant de-icing of the cone over a large portion. The cooling of the control system has also been improved.

According to one aspect of the invention:
the electrical de-icing switches arranged on the upstream section are configured to supply electrical power intermittently to at least one electrical de-icing member, and
the electrical de-icing switches arranged on the downstream section are configured to supply electrical power continuously to at least one electrical de-icing member.

The electrical de-icing switches in the upstream section thus dissipate more electrical power in the form of heat than in the downstream section, which allows a better de-icing of the upstream section which is more exposed to frost. The electrical de-icing switches in the downstream section thus continuously dissipate power, preventing the water that has run off following de-icing of an upstream section from refreezing, and possibly allowing it to be evaporated, preventing any risk of ice forming downstream of the downstream section.

According to one aspect of the invention:
the cone comprises a downstream part configured to be coupled in rotation to a shaft of the turbine engine and an upstream part removably attached to the downstream part,
at least one section extends in the upstream part and/or at least one section extends in the downstream part.

Advantageously, this type of architecture allows an easy maintenance of the electrical items of equipment mounted in the cone.

According to one aspect of the invention, the propeller comprises a plurality of access openings formed in the wall of the cone at the level of the downstream part. This allows to disconnect the electrical de-icing switches before disassembling the upstream part of the cone during maintenance.

According to one aspect of the invention, the electrical de-icing members are in the form of resistive elements or piezoelectric elements.

According to a preferred aspect of the invention, the electrical switches of the control system are in the form of thyristors, field effect transistors, bipolar transistors and/or insulated grid bipolar transistors.

According to a preferred aspect of the invention, the wall of the cone has a thermal conductivity greater than 20 W.m−1.K−1, preferably greater than 150 W.m−1.K−1, and preferably comprises aluminum or graphene. This encourages the heat exchanges between the wall of the cone and the electrical de-icing switches.

According to a preferred aspect, said at least one electrical de-icing switch is screwed to the wall of the cone, preferably at the level of an extra thickness of the wall of the cone. This encourages the heat exchanges by conduction between the wall of the cone and the electrical de-icing switches.

According to a preferred aspect, the propeller comprises at least one thermally conductive strip which is mounted on the inner face of the cone in contact with at least one electrical de-icing switch. This encourages the heat exchanges by conduction between the wall of the cone and the electrical de-icing switches.

The invention also relates to a method for de-icing a propeller for an aircraft turbine engine as described above, wherein:
from an input electrical power, each electrical switch distributes an output electrical power to the electrical de-icing members to de-ice the blades and emits a dissipated electrical power in the form of heat,
said at least one electrical de-icing switch transfers the dissipated electrical power by thermal conduction into the wall of the cone to ensure the cooling of the control system and the de-icing of the wall of the cone simultaneously.

The invention also relates to a method for maintaining an aircraft turbine engine propeller, consisting of:
Disconnecting said at least one electrical de-icing switch via said at least one access opening, then
Removing the front part of the cone from the downstream part of the cone.

The invention also relates to an aircraft turbine engine comprising a rotary transformer and a propeller as previously described, the rotary transformer comprising a rotor coupled in rotation to the propeller and a stator stationary mounted in the aircraft turbine engine, the rotary transformer being configured to transmit an alternating electric current to the control system of the propeller.

The aircraft turbine engine takes the form of a turboprop engine.

### PRESENTATION OF FIGURES

The invention will be better understood on reading the following description, given by way of example, with reference to the following figures, given by way of non-limiting examples, wherein identical references are given to similar objects.

FIG. 1 is a schematic perspective representation of an aircraft turbine engine propeller according to one embodiment of the invention.

FIG. 2 is a schematic perspective representation of an aircraft turbine engine propeller according to another embodiment of the invention.

FIG. 3 is a schematic representation in longitudinal half-section of the propeller according to a first embodiment of the invention.

FIG. 4 is a schematic cross-sectional representation of the electrical de-icing switches of FIG. 3.

FIG. 5 is a schematic representation in longitudinal half-section of the propeller according to a second embodiment of the invention.

FIG. 6 is a schematic representation in longitudinal half-section of the propeller according to a third embodiment of the invention.

FIG. 7 is a schematic representation in front view of an electrical de-icing switch mounted on the wall of the cone with thermally conductive elements according to one embodiment of the invention.

FIG. 8 and FIG. 9 are two schematic representations in profile view of the mounting of an electrical de-icing switch according to two alternative embodiments of the invention.

It should be noted that the figures set out the invention in detail in order to implement the invention, said figures of course being able to be used to better define the invention if necessary.

### DETAILED DESCRIPTION OF THE INVENTION

With reference to FIGS. 1 and 3, the invention relates to an aircraft turbine engine propeller 1 comprising:
a cone 2 extending along a longitudinal axis X oriented from upstream to downstream, the cone 2 being configured to be driven in rotation by a shaft of the aircraft turbine engine and comprising a wall 20 with an inner face 21, which is turned towards the longitudinal axis X, and an outer face 22, opposite the inner face 21,
blades 3,
electrical de-icing members 4 secured to a wall 30 of the blades 3 in order to de-ice them,
a control system 6 electrically connected to the electrical de-icing members 4 and comprising one or more electrical switches 7A with a variable switching duty cycle configured, on the basis of an input electrical power Pe, to distribute an output electrical power Ps to the electrical de-icing members 4 and to emit a dissipated electrical power Pd in the form of heat.

According to the invention and as illustrated in FIGS. 1 and 3, one or more electrical switches 7A of the control system 6, referred to as “electrical de-icing switches”, are mounted on the inner face 21 of the wall 20 of the cone 2 so as to transfer the dissipated electrical power Pd by heat conduction into the wall 20 of the cone 2.

Advantageously, the invention allows to promote the cooling of the control electronics mounted in the cone of the propeller to ensure the de-icing of the blades 3. Mounting the electrical switches 7A on the wall of the cone 2 allows the dissipated electrical power dissipated in the form of heat by the electrical switches 7A to be transferred to the wall of the cone 2 by thermal conduction. The heat emitted by the electrical switches 7A is thus effectively dissipated to the outside instead of accumulating inside the cone 2. No cooling device is required in the cone 2. Positioning the electrical switches in this way also makes it advantageous to contribute directly to the de-icing of the cone 2 of the propeller, as the dissipated electrical power dissipated in the form of heat by the electrical switches heats the wall of the cone 2 by thermal conduction.

With reference to FIG. 1, the propeller 1 is mounted in a rotating manner along the longitudinal axis X upstream of the aircraft turbine engine, more precisely upstream of the air inlet (not shown). The propeller 1 is driven in rotation by a rotating shaft of the turbine engine, in practice via a speed reducer known to the person skilled in the art as a Reduction Gear Box (RGB). Upstream and downstream are defined in relation to the longitudinal axis X of the cone 2 of the propeller 1, the top of which extends upstream and the base downstream. The blades 3 extend radially from the cone 2. The radial direction is defined in relation to that of the longitudinal axis X.

The invention has a particular advantage in the case of a propeller 1 of turboprop engine, which has a cone 2 that is longer than other turbine engine architectures, preferably more than once its diameter, which makes it more prone to the presence of ice. However, the invention applies to a propeller 1 of any type of turbine engine, ducted or non-ducted.

Preferably, the wall 20 of the cone 2 has a thermal conductivity greater than 20 W.m−1.K−1, preferably greater than 150 W.m−1.K−1. In one aspect, the wall 20 of the cone 2 is made of aluminum or graphene, which has a high thermal conductivity to improve the heat transfer between the electrical de-icing switches 7A and the wall 20. This helps to cool the electrical de-icing switches 7A and de-ice the cone 2.

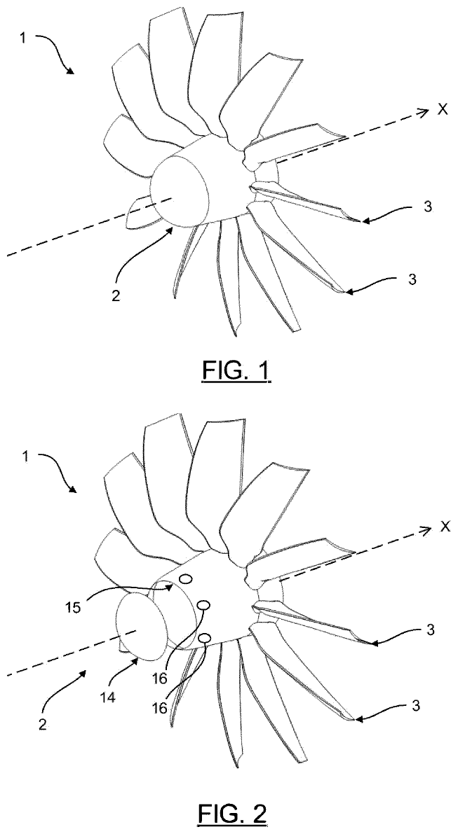

Also preferably, as illustrated in the example of FIG. 2, the cone 2 of the propeller 1 has an upstream part 14 and a downstream part 15, the upstream part 14 being removable from the downstream part 15. The cone 2 also has access openings 16 in the downstream part 15. As will be seen later, the removable upstream part 14 allows to facilitate the access to the items of equipment mounted in the cone 2 during a maintenance. Advantageously, the access openings 16 allow the electrical de-icing switches 7A, 7B to be disconnected before the upstream part 14 is dismantled.

With reference to FIG. 3, the electrical de-icing members 4 extend upstream of the blades 3, at the level of the leading edge, which is the area most prone to ice formation. The electrical de-icing members 4 are secured to the wall 30 of the blades 3, i.e. in this example mounted on the inner face 31 of the wall 30 so as to be protected from external conditions and to preserve the aerodynamic properties of the blades 3. Alternatively, the electrical de-icing members 4 are mounted on the outer face 32 of the wall 30 of the blades 3, for more effective de-icing. The electrical de-icing members 4 may also be integrated into the wall 30 of the blades 3 or mounted in a housing formed in the wall 30 of the blades 3.

As illustrated in FIG. 3, preferably, particularly in the case of a propeller 1 of turboprop engine, electrical de-icing members 5 are also secured to the wall 20 of the cone 2 to ensure de-icing. The electrical de-icing members 5 of the cone 2 preferably extend into the removable upstream part 14, which is most exposed to frost. As in the case of the blades 3, the electrical de-icing members 5 of the cone are either mounted on the outer face 22 of the wall 20 of the cone 2, as shown in FIG. 3, or on the inner face 21, or are integrated into the wall 20 of the cone 2, or are mounted in a housing formed in the wall 20 of the cone 2.

According to a preferred aspect, the electrical de-icing members 4, 5 of the blades 3 and/or of the cone 2 are in the form of resistive heating elements, such as resistive heating mats. The resistive heating elements comprise electrical resistors which are configured, when electrically supplied, to dissipate an electrical power in the form of heat in the wall of the blades 3 and/or of the cone 2. Heating the wall in this way prevents the formation of frost and/or removes any frost present from the wall.

Alternatively, the electrical de-icing members 4, 5 of the blades 3 and/or of the cone 2 are in the form of vibrating piezoelectric elements configured, when they are supplied with electricity, to deform mechanically and transmit mechanical stresses into the wall (vibrations), which prevents the formation of frost and/or detaches the frost present from the wall.

The electrical de-icing members 4, 5 may be powered continuously or intermittently depending on the de-icing requirement and their position on the propeller. According to a preferred aspect, the electrical de-icing members 4 secured to the wall of the blades 3 and the electrical de-icing members 5 secured to the upstream tip of the cone 2 are supplied intermittently. According to one aspect, the electrical de-icing members 5 mounted further downstream in the cone 2, for example at the downstream edge of the upstream part 14, are supplied with power continuously to prevent water from running off from the other upstream de-iced portions by evaporating said water run-off.

The electrical power supply is provided internally to the aircraft turbine engine, for example by a permanent magnet alternator mounted in the accessory gearbox, known to the person skilled in the art as the “Accessory Gear Box (AGB)”. The permanent magnet alternator produces a direct electric current from a torque applied to a rotating shaft in the turbine engine. An inverter converts the direct electric current into alternating electric current, which is transmitted by a rotating transformer to the control system 6 in the propeller 1. The rotating transformer comprises a rotor coupled in rotation to the propeller 1 and a stator mounted in a stationary part of the turbine engine, for example in the cavity delimited by the compressor casing. This aspect is known to the person skilled in the art and is not described further.

With reference to FIG. 3, the electrical power supplied to the electrical de-icing members 4, 5 is controlled by the control system 6, which is mounted in the rotating reference frame of the cone 2. The control system 6 comprises a control device 10 configured to distribute the electrical power dedicated to de-icing between the blades 3, as well as preferably the electrical power dedicated to controlling the pitch of the blades (not shown in FIG. 3). The electrical switching device 10, such as an analogue or digital electronic computer that distributes the power over time between the different heating parts, is preferably mounted along the longitudinal axis X to avoid generating an unbalanced effect in the cone 2.

As described previously, the control system 6 also comprises a set of electrical switches 7A with a variable switching ratio controlled by the control device 10 as a function, in particular, of the climatic conditions and the operating speed of the turbine engine. The electrical switches 7A are electrically connected to the control device 10 and to the electrical de-icing members 4, 5. The control device 10 is configured to supply an input electrical power Pe to the electrical switches 7A, which distribute an output electrical power Ps between the electrical de-icing members 4, 5. During operation, the electrical switches 7A dissipate a dissipated electrical power Pd dissipated in the form of heat, satisfying: Pe=Ps+Pd.

Preferably, the electrical switches 7A are in the form of thyristors, field effect transistors, bipolar transistors and/or insulated grid bipolar transistors (IGBT).

As described previously and illustrated in FIG. 3, at least some of the electrical switches 7A of the control system 6, and preferably all of them, are mounted on the inner face 21 of the wall 20 of the cone 2 and are referred to as “electrical de-icing switches” in that they help to de-ice the cone 2. This is because their assembly allows the dissipated electrical power Pd that they emit in the form of heat during operation to be transferred by thermal conduction.

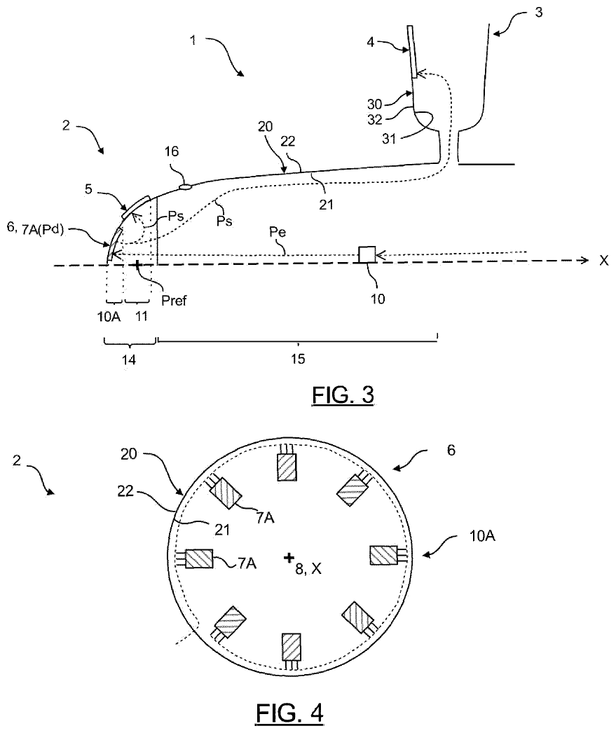

According to a first embodiment of the invention illustrated in FIGS. 3 and 4, the electrical de-icing switches 7A are positioned in the removable upstream part 14 of the cone 2, upstream of the electrical de-icing members 5. The electrical de-icing switches 7A are distributed circumferentially on the wall 20 of the cone 2 so that their common center of inertia 8 belongs to the longitudinal axis X. This avoids an unbalanced effect in the cone 2. The electrical de-icing switches 7A are aligned transversely with respect to the longitudinal axis X and are mounted on a portion of the wall 20 of the cone 2 forming a section 10A transverse with respect to the longitudinal axis X. The electrical de-icing switches 7A may alternatively extend in a staggered manner in the section 10A. The electrical de-icing switches 7A are, for example, distributed circumferentially around the longitudinal axis X and radially symmetrically with respect to the longitudinal axis X.

Still with reference to FIGS. 3 and 4, the electrical de-icing members 5 are also aligned or staggered transversely with respect to the longitudinal axis X and are mounted on a portion of the wall 20 of the cone 2 forming a section 11 transverse with respect to the longitudinal axis X. The section 11 of the electrical de-icing members 5 extends downstream of the section 10A of the electrical de-icing switches 7A. The longitudinal position of the section 11 of the electrical de-icing members 5 is hereinafter referred to as the “reference de-icing position Pref”.

In this example, both the electrical de-icing switches 7A and the electrical de-icing members 5 are mounted in the upstream part 14 of the cone 2 and ensure de-icing. The section 10 of the electrical de-icing switches 7A extends at the level of the leading edge of the cone 2, where the inlet air flow is lifted from the wall of the cone 2 and forms a stop point. The section 11 of the electrical de-icing members 5 extends downstream of the upstream portion 14, where the inlet air flow is attached to the wall of the cone 2.

Alternatively, the section 10A may comprise a single electrical de-icing switch 7A mounted along the longitudinal axis X at the level of the leading edge. The cone 2 may also be free of de-icing members 5 and the section 10A of electrical de-icing switches 7A may extend over all or part of the upstream part 14 of the cone 2, de-icing the cone 2 on its own.

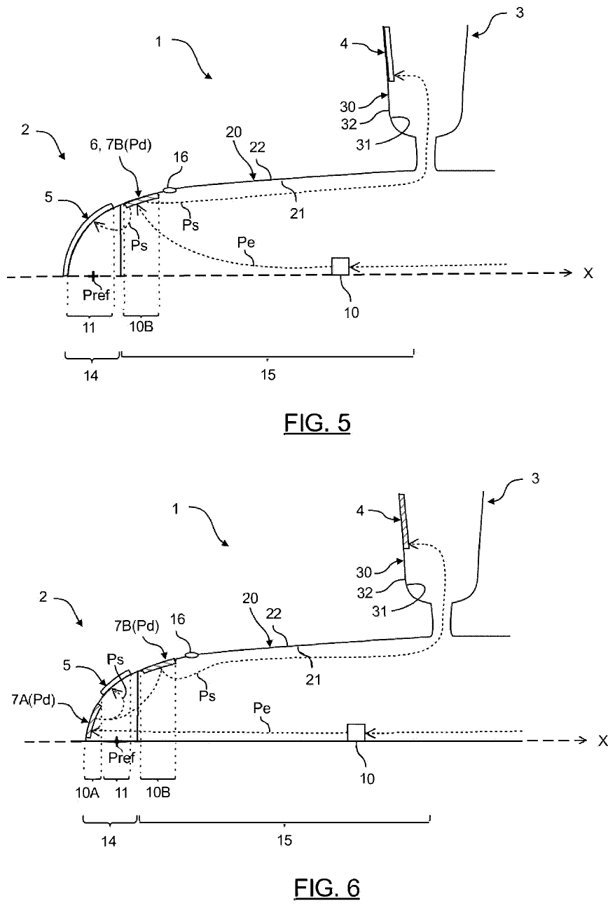

FIG. 5 illustrates a second embodiment of the invention, differing from the first in that the section 10B of electrical de-icing switches 7B extends downstream of the reference de-icing position Pref. In this example, the section 10B of electrical de-icing switches 7B extends into the downstream part 15 of the cone 2, preferably at the level of the upstream edge of the downstream part 15. The electrical de-icing switches 7B alone de-ice the downstream part 15 of the cone 2. The section 11 of electrical de-icing members 5 extends over all or part of the upstream part 14 of the cone 2 and de-ices it alone.

FIG. 6 illustrates a third embodiment of the invention, which is a combination of the embodiments of FIGS. 4 and 5. In this example, the cone 2 comprises an upstream section 10A and a downstream section 10B of electrical de-icing switches 7A, 7B extending respectively upstream and downstream of the reference de-icing position Pref. The upstream section 10A extends into the upstream part 14, while the downstream section 10B extends into the downstream part 15 of the cone 2.

According to a preferred aspect, the electrical de-icing switches 7A of the upstream section 10A are dedicated to the electrical supply of the electrical de-icing members 4, 5 providing a continuous de-icing, while those 7B of the downstream section 10B are dedicated to the electrical supply of the electrical de-icing members 4, 5 providing an intermittent de-icing. The power dissipated Pd is therefore greater in the upstream section 10A, which is more exposed to frost.

In the two embodiments shown in FIGS. 5 and 6, the cone 2 may be free of de-icing members 5 and the de-icing may be provided solely by the electrical de-icing switches 7A, 7B. In all the embodiments shown, the cone 2 may also comprise more than one section 10A, 10B of electrical de-icing switches 7A, 7B upstream and downstream of the reference de-icing position Pref.

According to a preferred aspect, in the example of FIGS. 4, 5 and 6, access openings 16 are formed in the downstream part 15 of the cone 2. Advantageously, the access openings 16 allow the electrical de-icing switches 7A mounted in the upstream part 14 to be electrically disconnected during maintenance, before the upstream part 14 is disassembled from the downstream part 15 of the cone 2.

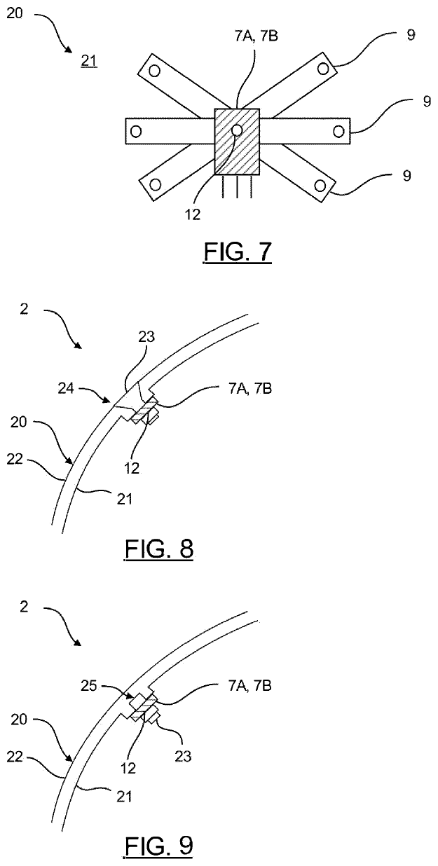

In all the embodiments shown, the electrical de-icing switches 7A, 7B are preferably screwed to the wall 20 of the cone 2, so as to ensure a good attachment and an efficient heat transfer by conduction. As illustrated in FIGS. 8 and 9, each electrical de-icing switch 7A, 7B comprises a through opening 12 into which is inserted an attachment member 23 which is attached to the wall 20, preferably at the level of an extra thickness. The attachment member 23 takes the form, for example, of an set of a screw or a stud with a nut.

In the example shown in FIG. 8, a through opening 24 is formed in the extra thickness of the wall 20 of the cone 2. The attachment member 23 is inserted from the outside into the through opening 12, 20 in the wall 20 and in the electrical de-icing switch 7A, 7B. In the example shown in FIG. 9, a blind opening 25 is formed in the extra thickness of the wall 20, facing the inner face 21. The attachment member 23 is inserted from the inside into the through opening 12 in the electrical de-icing member 7A, 7B and then into the blind opening 25 in the wall 20.

According to another preferred aspect illustrated in FIG. 7 and compatible with all the embodiments shown, one or more thermally conductive strips 9 are mounted on the inner face 21 of the wall 20 of the cone 2 in contact with an electrical de-icing switch 7A, 7B. The thermally conductive strips 9 preferably comprise aluminum, copper or graphene. This advantageously improves heat exchange between the electrical de-icing switch 7A, 7B and the wall 20 of the cone 2.

According to a preferred aspect, a thermally conductive paste is arranged between the wall 20 of the cone 2 and the electrical de-icing switch 7A, 7B and/or the thermally conductive strip 9. This improves the heat exchanges and bridges any surface defects between the two elements.

A method for using the propeller 1 described above, implemented on the ground or during aircraft flight in the presence of icing conditions or as a continuous preventive measure, is described below. The use method consists in:
from an input electrical power Pe, each electrical switch 7A, 7B of the control system 6 distributes an output electrical power Ps between the electrical members 4, 5 to de-ice the blades 3, and optionally the cone 2, and emits a dissipated electrical power Pd in the form of heat,
the electrical de-icing switches 7A, 7B of the control system 6 transfer the dissipated electrical power Pd by thermal conduction into the wall 20 of the cone 2.

As they are mounted against the wall 20 of the cone 2, the electrical de-icing switches 7A, 7B advantageously simultaneously cool the control system 6 and the de-icing of the cone 2.

1-10. (canceled)

11. A propeller for an aircraft turbine engine comprising a cone and a plurality of blades, the cone extending along a longitudinal axis oriented from upstream to downstream and being configured to be driven in rotation by a shaft of the aircraft turbine engine, the cone comprising a wall with an inner face and an outer face, the propeller comprising:
a plurality of electrical de-icing members secured to a wall of the blades in order to de-ice them;
a control system electrically connected to the electrical de-icing members and comprising at least one electrical switch having a variable switching duty cycle configured, using an input electrical power, to distribute an output electrical power to the electrical de-icing members and to emit a dissipated electrical power in the form of heat; and
wherein at least one of the at least one electrical switch of the control system, is an electrical de-icing switch mounted on the inner face of the wall of the cone so as to transfer the dissipated electrical power by thermal conduction into the wall of the cone.

12. The propeller according to claim 11, wherein the electrical de-icing switch or switches have an overall center of inertia belonging to the longitudinal axis.

13. The propeller according to claim 11, wherein the at least one electrical de-icing switch comprises a plurality of electrical de-icing switches, the electrical de-icing switches being arranged on at least one section of the cone extending transversely with respect to the longitudinal axis.

14. The propeller according to claim 13, comprising:
a plurality of electrical de-icing members secured to the wall of the cone and arranged on at least one section of the cone extending transversely with respect to the longitudinal axis and having a given longitudinal reference de-icing position; and
the electrical de-icing switches being arranged on an upstream section of the cone extending upstream of the reference de-icing position, or on a downstream section of the cone extending downstream of the reference de-icing position.

15. The propeller according to claim 13, comprising:
a plurality of electrical de-icing members secured to the wall of the cone and arranged on at least one section of the cone extending transversely with respect to the longitudinal axis and having a given longitudinal reference de-icing position; and
the electrical de-icing switches being arranged on an upstream section of the cone extending upstream of the reference de-icing position, and on a downstream section of the cone extending downstream of the reference de-icing position.

16. The propeller according to claim 15, wherein:
the electrical de-icing switches arranged on the upstream section are configured to supply electrical power intermittently to at least one of the electrical de-icing members; and
the electrical de-icing switches arranged on the downstream section are configured to supply electrical power continuously to at least one of the electrical de-icing members.

17. The propeller according to claim 3, wherein:
the cone comprises a downstream part configured to be coupled in rotation to a shaft of the turbine engine and an upstream part removably attached to the downstream part; and
the upstream section extends in the upstream part and/or the downstream section extends in the downstream part.

18. The propeller according to claim 17, comprising at least one access opening formed in the wall of the cone at the level of the downstream part.

19. The propeller according to claim 11, wherein the electrical de-icing members are in the form of resistive elements or piezoelectric elements.

20. A method for de-icing a propeller for an aircraft turbine engine according to claim 11, wherein:
from an input electrical power, each of the at least one electrical switch distributes an output electrical power to the electrical de-icing members to de-ice the blades and emits a dissipated electrical power in the form of heat; and
said at least one electrical de-icing switch transfers the dissipated electrical power by thermal conduction into the wall of the cone to ensure the cooling of the control system and the de-icing of the wall of the cone simultaneously.

21. A propeller for an aircraft turbine engine comprising a cone and a plurality of blades, the cone extending along a longitudinal axis oriented from upstream to downstream and being configured to be driven in rotation by a shaft of the aircraft turbine engine, the cone comprising a wall with an inner face and an outer face, the propeller comprising:
a plurality of electrical de-icing members secured to a wall of the blades in order to de-ice them;
a control system electrically connected to the electrical de-icing members and comprising at least one electrical switch having a variable switching duty cycle configured, using an input electrical power, to distribute an output electrical power to the electrical de-icing members and to emit a dissipated electrical power in the form of heat;
wherein at least one of the at least one electrical switch of the control system, is an electrical de-icing switch mounted on the inner face of the wall of the cone so as to transfer the dissipated electrical power by thermal conduction into the wall of the cone;
wherein the electrical de-icing switch or switches have an overall center of inertia belonging to the longitudinal axis; and
wherein the electrical de-icing members are in the form of resistive elements or piezoelectric elements.
